(19) United States
(12) Patent Application Publication
(10) Pub. No.: US 2017/0169854 A1
(43) Pub. Date: Jun. 15, 2017

(54) METHOD AND ELECTRONIC DEVICE FOR VIDEO STITCHING

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Hao CHEN, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,113

(22) Filed: Aug. 22, 2016

Related U.S. Application Data
(63) Continuation of application No. PCT/CN2016/089703, filed on Jul. 11, 2016.

(30) Foreign Application Priority Data
Dec. 15, 2015 (CN) 201510931471.9

(51) Int. Cl. G11B 27/036; G11B 27/30; H04N 9/87

(52) U.S. Cl. CPC G11B 27/036; H04N 9/87; G11B 27/3081; H04N 21/44016

(57) ABSTRACT

A method and an electronic device for stitching video are provided. The method includes: decomposing a stored video file; according to a location of video content to be stitched, stitching the video content to be stitched to the decomposed video file; and recombining the stitched video content to be stitched and the decomposed video file. In this way, video stitching is implemented on the client in an offline state, which facilitates diversified presentations of a video locally.

### CROSS-REFERENCE TO RELATED APPLICATIONS

The present disclosure is a continuation application of PCT application No. PCT/CN2016/089703 submitted on Jul. 11, 2016. This application is based upon and claims priority from Chinese Patent Application No. 201510931471.9, filed on Dec. 15, 2015 and entitled “CLIENT AND METHOD FOR VIDEO STITCHING”, the entire contents of which are incorporated herein by reference.

### TECHNICAL FIELD

This present disclosure relates to the field of video stitching, and more particularly, to g method and electronic device for video stitching.

### BACKGROUND

With the increase of requirements on video play, a lot of additional video information is stitched to a video in which a user is interested, for example, advertisement stitching in videos. However, generally, stitching between videos is implemented online, that is, different videos are generally stitched online, and stitching between videos cannot be implemented locally.

Video stitching is generally presented to a user by means of a network after stitching is completed. However, when a local client is offline, stitching between videos may not be implemented. For example, in a video offline play process, only a video itself may be played, and other additional videos may not be stitched to the video. In this way, diversified presentations of a video locally are hindered.

### SUMMARY

According to a first aspect, an embodiment of this present disclosure provides a method for video stitching, where the method includes: decomposing a stored video file; according to a location of video content to be stitched, stitching the video content to be stitched to the decomposed video file; and combining the stitched video content to be stitched and the decomposed video file.

According to a second aspect, an embodiment of the disclosure further provides a non-volatile computer storage medium, which stores computer executable instructions, where the computer executable instructions can be executed to perform any foregoing method for video stitching in this present disclosure.

According to a third aspect, an embodiment of this disclosure further provides an electronic device, including: at least one processor; and a memory communicably connected with the at least one processor for storing instructions executable by the at least one processor, where execution of the instructions by the at least one processor causes the at least one processor to perform any foregoing method for video stitching in this a present disclosure.

### BRIEF DESCRIPTION OF THE DRAWINGS

One or more embodiments are exemplarily described by figures corresponding thereto in the accompanying drawings; the exemplary descriptions do not constitute a limitation on the embodiments. Elements with the same reference numbers in the accompanying drawings are similar elements. Unless otherwise particularly stated, the figures in the accompanying drawings do not constitute a scale limitation.

The accompanying drawings are used to provide further understanding of the present disclosure, to form a part of the specification. The accompanying drawings are used to explain the present disclosure together with the following specific implementation manners, but do not form a limitation to the present disclosure. In the accompanying drawings:

FIG. 1 is a flowchart illustrating a method for video stitching according an embodiment of present disclosure;

FIG. 2 is a schematic structural diagram illustrating a client according to an embodiment of the present disclosure; and

FIG. 3 is a schematic structural diagram of hardware of an electronic device for executing a method for video stitching provided in an embodiment of this present disclosure.

### REFERENCE NUMERALS AND DENOTATIONS THEREOF

21 Decomposing module
22 Stitching module
23 Combining module

### DETAILED DESCRIPTION

Specific embodiments of the present disclosure are described hereinafter in detail with reference to the accompanying drawings. It should be understood that the specific embodiments described herein are merely used for describing and explaining the present disclosure, and are not intended to limit the present disclosure.

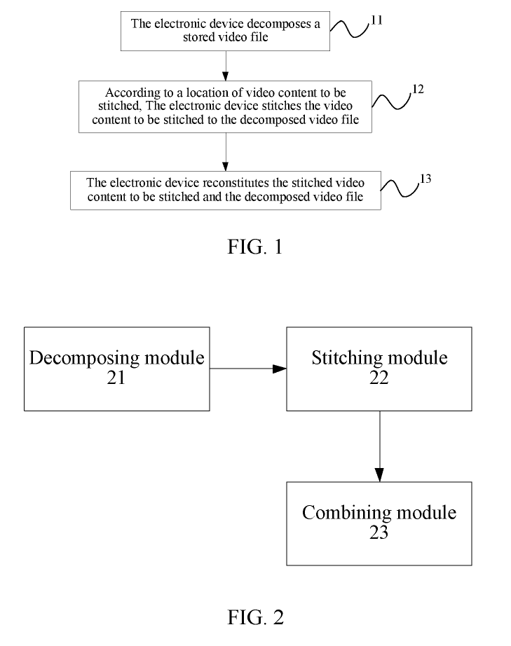

FIG. 1 is a flowchart illustrating a method for video stitching according an embodiment of present disclosure. As illustrated in FIG. 1, the video stitching method according to this embodiment of the present disclosure may include: in step 11, a stored video file is decomposed; in step 12, according to a location of video content to be stitched, the video content to be stitched is stitched to the decomposed video file; and in step 13, the stitched video content to be stitched and the decomposed video file are combined. In this way, video stitching is implemented on the client in an offline state, which facilitates diversified presentations of a video locally.

For example, after caching a video file locally, a user can decompose, in an offline state, the video file stored locally; for example, the video file stored locally is decomposed into video files in a frame format, or is decomposed into a plurality of video segments. Certainly, the present disclosure is not limited thereto. A person skilled in the art may decompose the video file stored locally into any suitable format to implement the technical solution of the present disclosure.

The video content to be stitched may be selected according to the actual needs, for example, an advertisement video, or a new movie propaganda video; the video content to be stitched can be also stored locally, and one or more kinds therein can be selected. The video content to be stitched may be video files in a frame format, or video segments; certainly, if needed, the video content to be stitched can be also converted into video files in a frame format or video segments, so as to facilitate stitching with the video file decomposed into a frame format or the video file decomposed into a plurality of video segments.

In one embodiment of the present disclosure, after caching a video file, a user can locally decompose the video file into video files in a frame format; a new movie propaganda video needing to be stitched is selected, and if needed, the new movie propaganda video can be converted into video files in a frame format; then the new movie propaganda video in a frame format can be stitched before a first frame, behind a last frame, and/or at a middle frame of the locally stored video file that is decomposed into a frame format, and certainly can be stitched at any frame or a plurality of frames of the locally stored video file that is decomposed into a frame format; after the decomposed video files and the new movie propaganda video are stitched, the decomposed video files and the new movie propaganda video can be combined so as to form a new video file. When the user plays the combined video file, the new movie propaganda video is played at a corresponding frame (for example, before a first frame, behind a last frame, and/or at a middle frame), so as to present diversity of the video file.

In another embodiment of the present disclosure, after caching a video file, a user can locally decompose the video file into a plurality of video segments; an advertisement propaganda video needing to be stitched is selected, and if needed, the advertisement propaganda video can be converted into video segments; then the advertisement propaganda video in the format can be stitched before a first video segment, behind a last video segment, and/or at a middle video segment of the locally stored video file that is decomposed into a plurality of video segments, and certainly can be stitched at any video segment or a plurality of video segments of the locally stored video file that is decomposed into a plurality of video segments; after the decomposed video files and the advertisement propaganda video are stitched, the decomposed video files and the advertisement propaganda video can be combined so as to form a new video file. When the user plays the combined video file, the advertisement propaganda video is played at a corresponding video segment (for example, before a first video segment, behind a last video segment, and/or at a middle video segment), so as to present diversity of the video file.

In addition, it should be understood that the new movie propaganda video and advertisement propaganda video may refer to a plurality of new movie propaganda videos and a plurality of advertisement propaganda videos, which can be separately stitched to different locations of the locally stored video file, that is, a plurality of pieces of same or different video content to be stitched can be stitched at a same location or different locations of the locally stored video file.

The video file is in an m3u8 format.

Correspondingly, an embodiment of the present disclosure further provides a client. FIG. 2 is a schematic structural diagram of a client provided according to an embodiment of the present disclosure. As shown in FIG. 2, the client provided in the present disclosure may include: a decomposing module 21, a stitching module 22, and a combining module 23. The decomposing module 21 decomposes a stored video file; the stitching module 22 stitches, according to a location of video content to be stitched, the video content to be stitched to the decomposed video file; and the combining module 23 combines the stitched video content to be stitched and the decomposed video file. In this way, video stitching is implemented on the client in an offline state, which facilitates diversified presentations of a video locally.

For example, after caching a file document on a client, a user can decompose the video file stored on the client in an offline state, for example, the decomposing module 21 can decompose the stored video file into video files in a frame format; or the decomposing module 21 can decompose the stored video file into a plurality of video segments. Certainly, the present disclosure is not limited thereto. A person skilled in the art can decompose the video file stored locally into any suitable format to implement the technical solution of the present disclosure.

The video content to be stitched may be selected according to the actual needs, for example, an advertisement video, or a new movie propaganda video; the video content to be stitched can be also stored locally, and one or more kinds therein can be selected. The video content to be stitched may be video files in a frame format, or video segments; certainly, if needed, the video content to be stitched can be also converted into video files in a frame format or video segments, so as to facilitate stitching with the video file decomposed into a frame format or the video file decomposed into a plurality of video segments.

In one embodiment of the present disclosure, after a user caches a video file on a client, a decomposing module 21 can locally decompose the video file into video files in a frame format; a stitching module 22 can select a new movie propaganda video needing to be stitched, and if needed, the new movie propaganda video can be converted into video files in a frame format; then the new movie propaganda video in a frame format can be stitched before a first frame, behind a last frame, and/or at a middle frame of the locally stored video file that is decomposed into a frame format, and certainly can be stitched at any frame or a plurality of frames of the locally stored video file that is decomposed into a frame format; after the decomposed video files and the new movie propaganda video are stitched, a combining module 23 can combine the decomposed video files and the new movie propaganda video so as to form a new video file. When the user plays the combined video file, the new movie propaganda video is played at a corresponding frame (for example, before a first frame, behind a last frame, and/or at a middle frame), so as to present diversity of the video file.

In another embodiment of the present disclosure, after a user caches a video file on a client, a decomposing module 21 can locally decompose the video file into a plurality of video segments; a stitching module 22 can select an advertisement propaganda video needing to be stitched, and if needed, the advertisement propaganda video can be converted into video segments; then the advertisement propaganda video in the format can be stitched before a first video segment, behind a last video segment, and/or at a middle video segment of the locally stored video file that is decomposed into a plurality of video segments, and certainly can be stitched at any video segment or a plurality of video segments of the locally stored video file that is decomposed into a plurality of video segments; after the decomposed video files and the advertisement propaganda video are stitched, a combining module 23 can combine the decomposed video files and the advertisement propaganda video so as to form a new video file. When the user plays the combined video file, the advertisement propaganda video is played at a corresponding video segment (for example, before a first video segment, behind a last video segment, and/or at a middle video segment), so as to present diversity of the video file.

In addition, it should be understood that the new movie propaganda video and advertisement propaganda video may refer to a plurality of new movie propaganda videos and a plurality of advertisement propaganda videos, which can be separately stitched to different locations of the locally stored video file, that is, a plurality of pieces of same or different video content to be stitched can be stitched at a same location or different locations of the locally stored video file.

The video file is in an m3u8 format.

An embodiment of the present disclosure provides a non-transitory computer-readable storage medium which stores computer executable instructions. The computer executable instructions can be executed to perform a video stitching method disclosed in any one of the above described method embodiments.

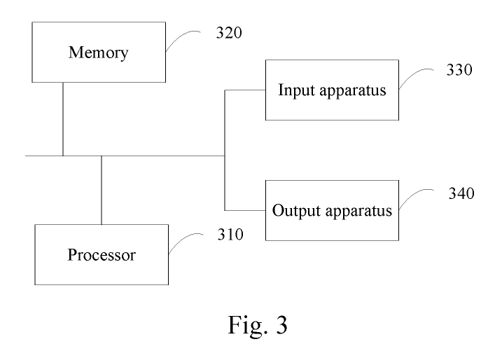

Correspondingly, FIG. 3 is a schematic diagram of hardware of an electronic device for executing a video stitching method provided in an embodiment of this present disclosure. As shown in FIG. 3, the electronic device includes: one or more processors 310 and a memory 320, with one processor 310 as an example in FIG. 3.

A device for executing the video stitching method may further include: an input apparatus 330 and an output apparatus 340.

The processor 310, the memory 320, the input apparatus 330, and the output apparatus 340 can be connected by means of a bus or in other manners. A connection by means of a bus as an example in FIG. 3.

As a non-transitory computer-readable storage medium, the memory 320 can be used to store non-transitory software programs, non-volatile computer executable programs and modules, for example, program instructions/module corresponding to the video stitching method in the embodiments of this present disclosure (for example, the decomposition module 21, the stitching module 22, and the combining module 23 shown in FIG. 2). The processor 310 executes various functional present disclosures and data processing of the server, that is, implements the video stitching method of the foregoing method embodiments, by running the non-volatile software programs, instructions, and modules that are stored in the memory 320.

The memory 320 may include a program storage area and a data storage area, where the program storage area may store an operating system and an present disclosure that is needed by at least one function; the data storage area may store data created according to use of the video stitching apparatus, and the like. In addition, the memory 320 may include a high-speed random access memory, or may also include a non-volatile memory such as at least one disk storage device, flash storage device, or another non-volatile solid-state storage device. In some embodiments, the memory 320 optionally includes memories that are remotely disposed with respect to the processor 310, and the remote memories may be connected, via a network, to the video stitching apparatus. Examples of the foregoing network include but are not limited to: the Internet, an intranet, a local area network, a mobile communications network, or a combination thereof

The input apparatus 330 can receive entered digits or character information, and generate key signal inputs relevant to user setting and functional control of the video stitching apparatus. The output apparatus 340 may include a display device, for example, a display screen.

The one or more modules are stored in the memory 320; when the one or more modules are executed by the one or more processors 310, the video stitching method in any one of the foregoing method embodiments is executed.

The foregoing product can execute the method provided in the embodiments of this present disclosure, and has corresponding functional modules for executing the method and beneficial effects. Refer to the method provided in the embodiments of this present disclosure for technical details that are not described in detail in this embodiment.

The electronic device in this embodiment of this present disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) Other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this present disclosure, rather than limit this present disclosure. Although this present disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this present disclosure.

What is claimed is:

1. A method for stitching video, applied in an electronic device, comprising:
decomposing a stored video file;
stitching, according to a location of video content to be stitched, the video content to be stitched to the decomposed video file; and
recombining the stitched video content to be stitched and the decomposed video file.

2. The method according to claim 1, wherein the decomposing a stored video file comprises: decomposing the stored video file into video files in a frame format.

3. The method according to claim 1, wherein the video content to be stitched is video content in a frame format.

4. The method according to claim 1, wherein the decomposing a stored video file comprises: decomposing the stored video file into a plurality of video segments.

5. The video stitching method according to claim 1, wherein the video content to be stitched is video segment.

6. The video stitching method according to claim 1, wherein the video file is in an m3u8 format.

7. A non-transitory computer-readable storage medium, which stores computer executable instructions that, when executed by an electronic device, cause the electronic device to:
decompose a stored video file;
stitch, according to a location of video content to be stitched, the video content to be stitched to the decomposed video file; and
recombine the stitched video content to be stitched and the decomposed video file.

8. The non-transitory computer-readable storage medium according to claim 7, wherein the instructions to decompose a stored video file cause the electronic device to: decompose the stored video file into video files in a frame format.

9. The non-transitory computer-readable storage medium according to claim 7, wherein the video content to be stitched is video content in a frame format.

10. The non-transitory computer-readable storage medium according to claim 7, wherein the instructions to decompose a stored video file cause the electronic device to:
decompose the stored video file into multiple video segments.

11. The non-transitory computer-readable storage medium according to claim 7, wherein the video content to be stitched is video segment.

12. The client according to claim 7, wherein the video file is in an m3u8 format.

13. An electronic device, comprising:
at least one processor; and
a memory communicably connected with the at least one processor for storing instructions executable by the at least one processor, where execution of the instructions by the at least one processor causes the at least one processor to:
decompose a stored video file;
stitch, according to a location of video content to be stitched, the video content to be stitched to the decomposed video file; and
recombine the stitched video content to be stitched and the decomposed video file.

14. The electronic device according to claim 13, wherein the execution of the instructions to decompose a stored video file causes the at least one processor to: decompose the stored video file into video files in a frame format.

15. The electronic device according to claim 13, wherein the video content to be stitched is video content in a frame format.

16. The electronic device according to claim 13, wherein the execution of the instructions to decompose a stored video file causes the at least one processor to: decompose the stored video file into multiple video segments.

17. The electronic device according to claim 13, wherein the video content to be stitched is video segments.

18. The electronic device according to claim 13, wherein the video file is in an m3u8 format.
